(19) United States
(12) Patent Application Publication
(10) Pub. No.: US 2010/0026499 A1
(43) Pub. Date: Feb. 4, 2010

(54) REAL TIME COMPLIANCE MONITORING SYSTEM (RTCMS) FOR IN HOME MEDICAL REAL TIME COMPLIANCE MONITORING SYSTEM (RTCMS) FOR IN HOME MEDICAL EQUIPMENT

(76) Inventor: Ellen Kristie Lamb, Maple Valley, WA (US)

Correspondence Address: Steven Corey, 22620 262 SE, Maple Valley, WA, 98038, US

(21) Appl. No.: 12/409,291

(22) Filed: Mar. 23, 2009

Related U.S. Application Data
(60) Provisional application No. 61/039,231, filed on Mar. 25, 2008.

(51) Int. Cl. G08B 23/00; H04N 7/18

(52) U.S. Cl. 340/573.1; 348/77; 348/77; 348/E07.085

(57) ABSTRACT

A compliance monitoring method and system provides more reliable compliance with the proper operation of in-home medical equipment such as a Continuous Positive Air Pressure (CPAP) device. The system monitors the in-home medical equipment and when the system detects an alarm signal from the in-home medical equipment indicative of an anomalous operating condition the system will transmits an alarm signal to a responsible care giver.

### CROSS REFERENCE TO RELATED APPLICATIONS

This application claims priority to U.S. Provisional Application No. 61/039,231 filed on 25 Mar. 2008 by Ellen Lamb entitled “Real-Time Compliance Monitoring System (RTC-MS) for Continuous Positive Airway Pressure (CPAP)” the contents of which are incorporated herein by reference.

### TECHNICAL FIELD

The present disclosure relates to home operated medical equipment and more specifically warning systems to alert caregivers to anomalous operation of home operated medical equipment.

### BACKGROUND

Many types of medical equipment are designed for non-clinical, in-home use. The benefits of such equipment allows people with mild medical conditions the freedom of living at home and less sequent visits to a medical facility than would be required without such equipment. The use of such equipment requires a certain amount of diligence on the patient's part to ensure that the equipment is properly used.

Medical equipment designed for in-home use usually includes a monitoring system specifically designed to sense anomalous operations and activate an alarm signal to notify the user that corrective action must be taken to ensure the equipment continues to provide the intended benefit to the patient. The alarm signal is usually an electrical signal that drives an auditory transducer such as a speaker (or buzzer) or the transducer may be a visual transducer such as a light or LED. The monitoring and alarm systems presently in use., however, are not fully reliable. Users of medical equipment such as a Continuous Positive Air Pressure (CPAP) device, for example, are required to wear a mask covering the nose or mouth and nose throughout the night, while they are asleep. An audible alarm system is often an integrated element of the CPAP to announce an anomalous condition in either the machine hardware or the patient's airflow. Nevertheless, users are known to occasionally wake up in the morning to discover the alarm sounding and the nosepiece is no longer in position, rendering the CPAP ineffective.

Another risk of using medical devices at home is the risk of a household power outage. Most CPAP devices do not include an integrated backup power system. A properly functional CPAP, properly worn, represents a risk of suffocation through the re-breathing of exhaled air if the CPAP (including the CPAP alarm system) loses power.

While the alarm system provided by the medical device's manufacture may be effective in detecting an anomalous condition and generating an alarm signal, the reliability of the system as a whole can be improved.

### SUMMARY

The unreliability of the existing systems is due to their reliance on the patient to rationally respond to an alarm signal. Often the patient is unable to rationally respond to the medical equipment's alarm due to the patient's immaturity, disability, temporarily impaired alertness (drowsiness), or other reasons.

An embodiment of the invention is a system that alerts a responsible caregiver that the medical device has determined the presence of an anomalous operating condition and has generated an alarm signal. Compliance with the medical equipment operating requirements is thereby made more reliable.

The features, functions, and advantages that have been discussed can be achieved independently in various embodiments of the present disclosure or may be combined in yet other embodiments further details of which can be seen with reference to the following description and drawing.

### BRIEF DESCRIPTION OF THE DRAWINGS

The above mentioned features of this disclosure will become more clearly understood from the following detailed description read together with the drawings in which:

FIG. 1 is an illustration of an advantageous embodiment showing schematic the components of a home-use medical system and the Real Time Compliance Monitor System.

FIG. 2 is a functional and logical flow diagram illustrating operations of the Real Time Compliance Monitor System.

### DETAILED DESCRIPTION

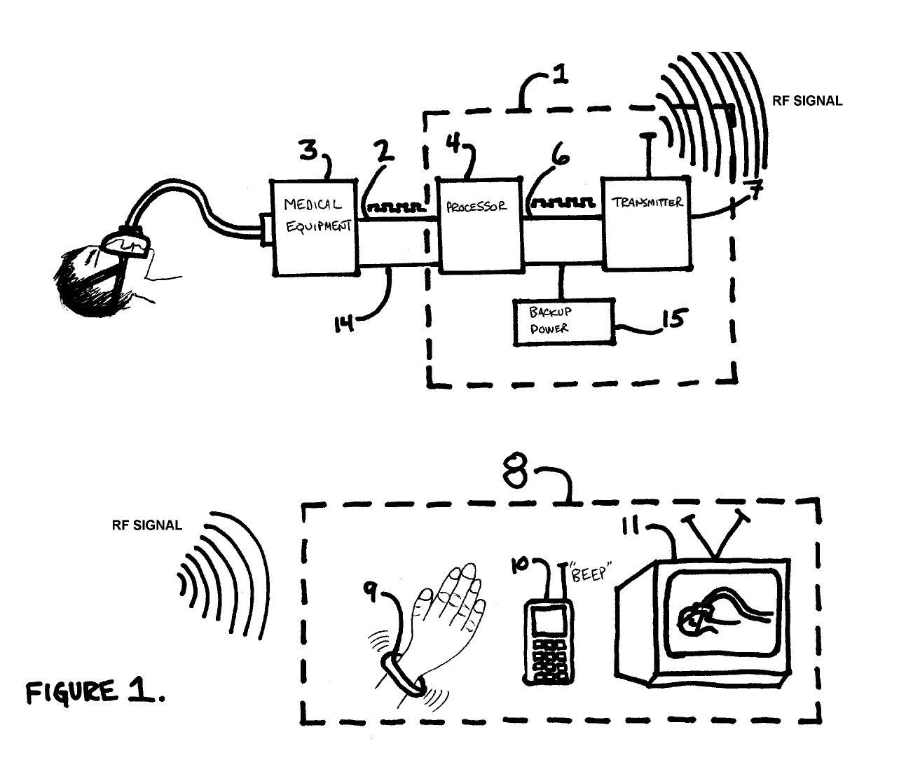

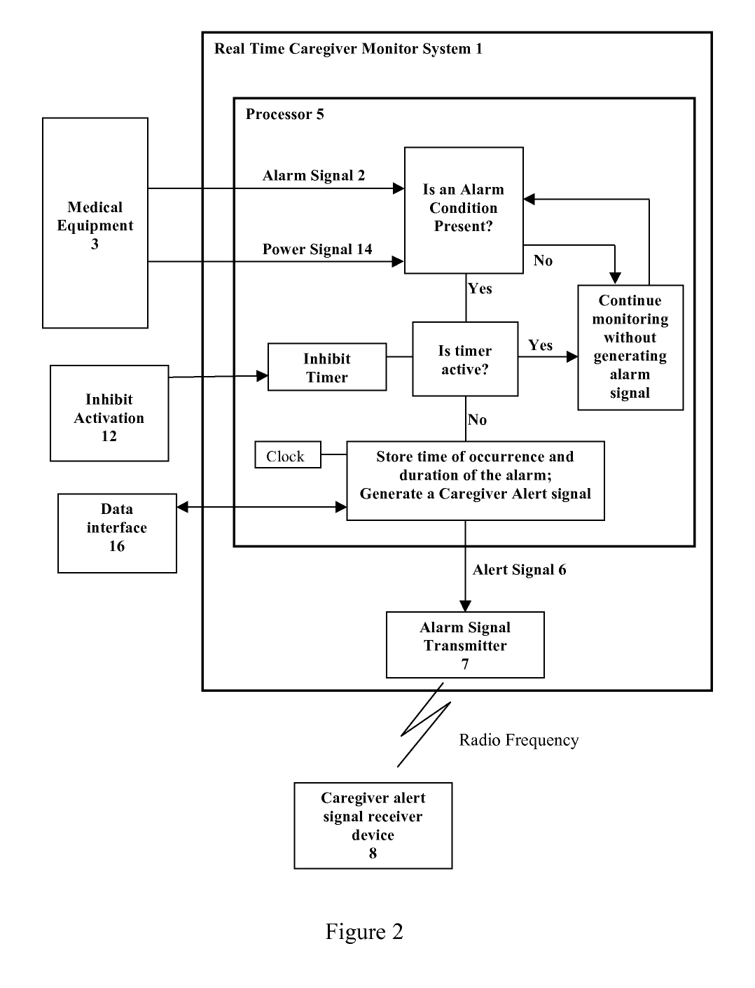

As shown in FIGS. 1 and 2, The Real Time Compliance Monitoring System (RTCMS) [1] receives an alarm signal [2] that is generated by an in-house medical equipment component [3]. The alarm processor [4] receives the alarm signal [2] from the medical equipment component [3]. The processor [4] may be adapted to receive an audio, electronic, or other alarm signal from the medical equipment [3] indicative of an alarm condition. In response to receiving the alarm signal [2], the processor generates a caregiver alert signal [6]. A radio frequency (RF) transmitter [7] emits the alert signal [6] to a caregiver receiving device [8]. The receiving device [8] may be one that provides a physical, audible, video, or other stimulus to the caregiver. Examples of such receiver device include a vibrating bracelet [9], a personal electronic device [10], cellular phone, video monitor system [11], computer, etc.

The alert signal transmitted by the RTMCS may also be used to initiate a response by systems such as home monitoring systems which often employ centralized call centers which, when necessary, alert local rapid response emergency agencies.

The RTCMS includes an alert inhibit function that is responsive to activation by a user (the patient or caregiver) [12], the depression of an inhibit button for example, whereby the alert signal is temporarily inhibited for a predetermined period of time [13] to accommodate a known or expected inoperative condition of the medical equipment such as while the caregiver is correcting the anomalous condition which initiated the medical alarm. The inhibit function also allows the patient to adjust or temporarily remove the equipment without alerting the caregiver.

The RTCMS may also be adapted to include a clock and the ability to store important data regarding the alarm signal [2]. The time, frequency, or duration of the medical equipment alarm signal, for example, may be stored in a memory device then down-loaded and used in subsequent evaluation by a medical professional.

Power outages represent a particular concern to those who are dependant on the operation of medical equipment [3]. Accordingly the RTCMS can be adapted to operate on household power with a backup power system [15], a battery for example.

The RTCMS can be adapted to detect the on/off state of the medical equipment [3] and respond with a caregiver alert signal [6]. Accordingly, the RTCMS can be adapted to receive a signal [14] directly from the medical equipment [3] indicative of its on/off state; alternatively it can employ a system able to sense the amount of power consumed by the medical equipment and determine whether or not it is consuming quantities of power indicative of normal operation. Thus, if there is a power outage or if the patient is awoken from sleep and semi-consciously disables the medical device, the RTCMS will sense the drop in power, determine the device has been turned off or disabled, then respond by providing an alert to the caregiver that the medical equipment is no longer operative and the patient should be woken, the medical device replaced, or an alternative power source for the medical equipment should be enabled.

It is not unusual that a single patient may rely on the proper operation of more than one home-use medical equipment devices simultaneously such as a CPAP, oxygen dispenser, feeding device, drip devise, etc. Accordingly the RTCMS can be readily adapted such that it can monitor the alarm signals from a plurality of medical equipment.

The RF wireless communication can use any portion of available, appropriate spectrum including, but not limited to standard spread-spectrum 900 Mhz, wireless networking (IEEE 802.11a/b/g), or cellular phone networks to communicate with devices that operate on these frequencies. Preferably the RF communication will incorporate digital encryption and security to ensure there is no interference or intrusion between the RTCMS signal and other appliances that use the same frequency range.

The RTCMS system and its broader aspects are not limited to the specific details, representative apparatus and methods, and illustrative examples shown and described. Accordingly, departures may be made from such details without departing from the spirit or scope of applicant's general inventive concept.

What is claimed is:

1. A method for providing reliable operation of in-home medical equipment, the method comprising the steps of:
detecting an anomalous operating condition of the medical equipment; and
responding to said anomalous operating condition by providing a alerting signal to a care giver.

2. The method of claim 1 wherein detecting an anomalous condition comprises monitoring said in-home medical equipment for an alarm signal

3. The method of claim 1 wherein detecting an anomalous condition comprises monitoring a signal indicative of the medical equipment's power consumption.

4. A system for providing reliable use of in-home medical equipment, the system comprising:
an alarm processor responsive to a medical equipment alarm signal and generating an outgoing caregiver alert signal in response to the medical equipment alarm signal; and,
a transmitter for transmitting said caregiver alert signal to a caregiver receiving device.

5. The system of claim 4 wherein said processor is further responsive to activation of an inhibit function by a user and inhibits generation of the alert signal for a pre-determined period of time in response to said activation.

6. The system of claim 4 wherein the caregiver receiving device responsive to the transmitted caregiver alert signal, said receiving device generating a stimulus to a caregiver in response to the transmitted caregiver alert signal.

7. The system of claim 4 further comprising an auxiliary power source capable of providing power to said processor and transmitter, said auxiliary power source being separate from a primary power source which provides for operation of the system, the auxiliary power source providing power in the event of a primary power outage.

8. The system of claim 4 wherein the processor is responsive to the on/off state of the operational power for the medical equipment and generates a caregiver alert signal to said transmitter if the equipment is turned off.

9. The system of claim 4 wherein the processor is responsive to the power consumption of the medical equipment and generates a caregiver alert signal when the medical equipment is consuming inadequate power to achieve the medical equipment's objective.

10. The system of claim 4 wherein said processor is adapted to respond to one or more audio alarm signals provided by said medical equipment.

11. The system of claim 4 wherein said processor is adapted to respond to one or more electrical alarm signals provided by said medical equipment.

12. The system of claim 4 further comprising:
a video monitor system responsive to said caregiver alert signal and providing a video image of the user of said medical equipment to the caregiver in response to said alarm detection signal.

13. The system of claim 4 further comprising means to detect, store, and output data regarding the alarm signal.

14. The system of claim 13 wherein said data regarding the alarm signal comprises the time, frequency, or duration of the medical equipment alarm.
